(19) United States
(12) Patent Application Publication
(10) Pub. No.: US 2021/0136192 A1
(43) Pub. Date: May 6, 2021

(54) HOUSING STRUCTURE COMPRISING PANEL ELEMENTS FOR AN ELECTRONIC DEVICE

(71) Applicant: Huawei Technologies Co., Ltd., Shenzhen (CN)

(72) Inventors: Hongxue ZHANG, Kista (SE); Jue LI, Helsinki (FI); Guoping LUO, Kista (SE)

(21) Appl. No.: 16/970,208

(22) PCT Filed: Feb. 14, 2018
(86) PCT No.: PCT/EP2018/053646

§ 371 Date: Aug. 14, 2020

(51) Int. Cl. H04M 1/18; H05K 5/00; H04M 1/02; G06F 1/18

(52) U.S. Cl. CPC H04M 1/185; G06F 1/181; H04M 1/026; H05K 5/0017

(57) ABSTRACT

A housing structure for an electronic device comprises a support frame, supporting a front, a rear, and a side panel elements of the housing structure such that they are less sensitive to damages.

### CROSS-REFERENCE TO RELATED APPLICATIONS

This application is a National Stage of International Application No. PCT/EP2018/053646, filed on 14 Feb. 2018, which is hereby incorporated by reference in its entirety.

### TECHNICAL FIELD

The disclosure relates to a housing structure for an electronic device comprising a front panel element and a rear panel element, a side panel element bridging a gap formed between the front panel element and the rear panel element.

### BACKGROUND

The design of an electronic device is a key factor for its success in the marketplace. Possible design choices include the choice of material used for the external housing of the electronic device, which, over the years, has changed from a plastic housing to more high-end housings comprising a combination of metal and glass.

The durability of glass panel is a concern due to several factors, including glass being a brittle material requiring specific treatment such as chemical strengthening, natural weak points at edges, and residual stress created during the glass panel forming process. Nevertheless, there is a need for providing high-end housings which may be provided with separate panels, e.g. made of glass, not only on the front and rear of the housing structure, but also along its sides.

### SUMMARY

It is an object to provide an improved housing structure suitable for use in an electronic device. The foregoing and other objects are achieved by the features of the independent claims. Further implementation forms are apparent from the dependent claims, the description, and the figures.

According to a first aspect, there is provided a housing structure for an electronic device comprising a front panel element and a rear panel element, a side panel element bridging a gap formed between the front panel element and the rear panel element, a support frame supporting the front, rear, and side panel element, the support frame comprising a center frame member extending in between the front and rear panel elements, an end frame member arranged at an edge of the center frame member, the front, rear, and side panel elements being attached to the end frame member.

Such a housing structure provides extra stability to the electronic device, as well as support for the panel elements which together form the housing of the electronic device. The individual panel elements are supported by the support frame in a way which makes them less sensitive to damage. Furthermore, the support frame allows all sides of the housing structure, and hence the electronic device, to be covered by panel elements such that an attractive, cohesive design may be achieved.

In a possible implementation form of the first aspect, the support frame comprises a plurality of end frame members, the end frame members being arranged at opposing edges of the center frame member, the center frame member extending continuously between the end frame members, providing a simple and symmetric structure which also gives extra support to the electronic device into which the support frame is to be fitted.

In a further possible implementation form of the first aspect,

the end frame member comprises a plate extending perpendicular to a main plane of the center frame member, the front and rear panel elements being attached to opposing edges of the end frame member, the side panel element being attached to an outer face of the end frame member, the outer face extending between the opposing edges of the end frame member, providing a simple yet effective support structure.

In a further possible implementation form of the first aspect,

the end frame member comprises a web and two flanges, the web of the end frame member extending perpendicular to a main plane of the center frame member and the edge of the center frame member being attached to the web of the end frame member, the front and rear panel elements being attached to opposing flanges of the end frame member, the side panel element being attached to the web of the end frame member, facilitating a support frame which provides improved support for the panel elements.

In a further possible implementation form of the first aspect,

the flanges of the end frame member comprise at least a plate-shaped section which extends in parallel with the center frame member and in a direction away from the center frame member such that the web and flanges form a groove, the side panel element being arranged in the groove, surrounded at two sides by the flanges, such that the side panel elements are well secured to the support frame and partially surrounded, and protected, by the same.

In a further possible implementation form of the first aspect,

the flanges of the end frame member protrude past an outer face of the side panel element, arranged in the groove, in a direction away from the center frame member, allowing shock, e.g. caused by dropping the electronic device on the floor, to be at least partially absorbed and hence reducing the risk of the panel elements being damaged.

In a further possible implementation form of the first aspect,

the flanges of the end frame member comprise at least a curved section, attached to the web of the end frame member, the flanges of the end frame member extending in a direction towards the center frame member, providing extra support and reinforcement to the edges of the panel elements.

In a further possible implementation form of the first aspect,

the flange of the end frame member has an inner face and an outer face, the front and rear panel elements being attached to the outer faces of opposing flanges of the end frame member, providing a large surface for the panel elements to be securely attached to.

In a further possible implementation form of the first aspect,

at least one of the front panel element or the rear panel element has curved side sections, and an edge of the curved side section is attached to the outer face of the flange of the end frame member, allowing the flanges to protrude past the panel elements, towards the exterior, such that they can absorb shock, e.g., caused by dropping the electronic device on the floor.

In a further possible implementation form of the first aspect,

at least one of the front panel element or the rear panel element has curved side sections, and a rear face of the curved side section is attached to the outer face of the flange of the end frame member, providing extra support and reinforcement to the curved side sections of the panel elements.

In a further possible implementation form of the first aspect,

at least one of the front panel element or the rear panel element is plate-shaped, and a rear face of the front panel element or the rear panel element is attached to the outer face of the flange of the end frame member, providing extra support and reinforcement to the flat side sections of the panel elements.

In a further possible implementation form of the first aspect,

the support frame is made of metal, allowing the support frame to be both sufficiently rigid and lightweight.

In a further possible implementation form of the first aspect,

the front panel element, the rear panel element, and the side panel elements are made of glass, facilitating a contemporary design for the housing structure and in addition allowing an easier antenna design as no metal structures block incoming or outgoing radio waves.

In a further possible implementation form of the first aspect,

the front, the rear, and the side panel elements are attached to the support frame by means of adhesive, facilitating simple and cost-effective assembly of the housing structure.

According to a second aspect, there is provided an electronic device comprising a housing structure according to the above. The housing structure provides extra stability to the electronic device, as well as support for the panel elements which together form a hollow shell. The individual panel elements are supported by the support frame in a way which makes them less sensitive to damage. Furthermore, the support frame allows all sides of the housing structure, and hence the electronic device, to be covered by panel elements such that an attractive design may be achieved.

This and other aspects will be apparent from and the embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 shows a perspective view of an electronic device in accordance with one embodiment of the present invention;

FIG. 2 shows a perspective view of an electronic device in accordance with another embodiment of the present invention;

FIG. 3 shows a cross-sectional part view of a housing structure in accordance with one embodiment of the present invention;

FIG. 4 shows a cross-sectional part view of a housing structure in accordance with another embodiment of the present invention;

FIG. 5 shows a further cross-sectional part view of the embodiment shown in FIG. 3;

FIG. 6 shows a further cross-sectional part view of the embodiment shown in FIGS. 3 and 5;

FIG. 7 shows a further cross-sectional part view of the embodiment shown in FIG. 4;

FIG. 8 shows a further cross-sectional part view of the embodiment shown in FIGS. 4 and 7;

FIG. 9 shows a cross-sectional part view of a housing structure in accordance with another embodiment of the present invention; and

FIG. 10 shows a further cross-sectional part view of the embodiment shown in FIG. 9.

### DETAILED DESCRIPTION

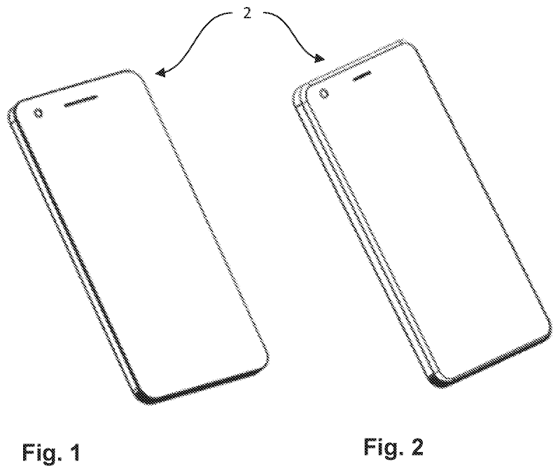

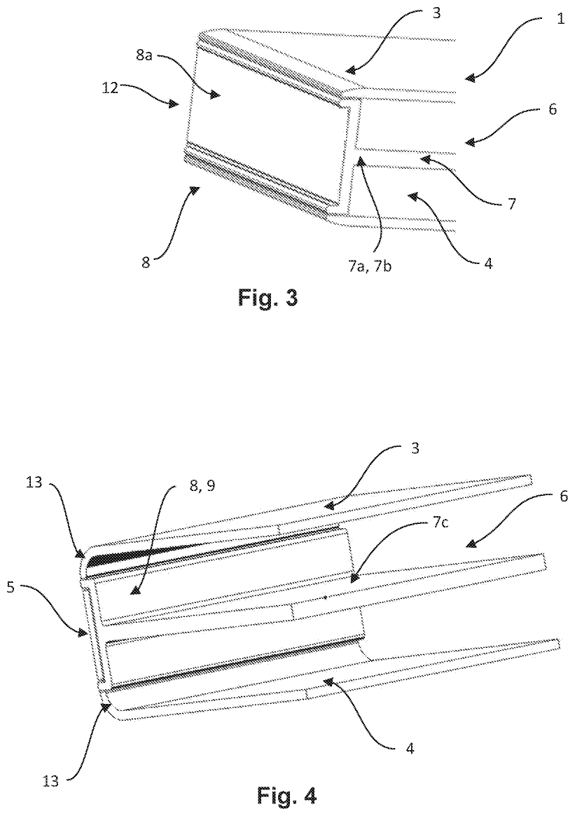

As seen in FIGS. 1 and 2, electronic devices may have differently designed front panel elements 3 and rear panel elements 4. FIG. 1 shows a so called 2D/2,5D panel element, and FIG. 2 shows a 3D panel element. 2D refers to the edge of the glass panel element being straight, 2.5D refers to the edge having a slight curvature, and 3D refers to the edge having a larger curvature. 2D is shown more clearly in FIGS. 3, and 3D is shown more clearly in FIG. 4.

The electronic device 2, regardless of the design of the front panel element 3 and rear panel element 4, comprises a housing structure 1 within which further components are arranged, such as the display, battery, circuit board, etc. The housing structure 1 comprises the above-mentioned front panel element 3 and rear panel element 4, as well as one or several side panel elements 5. The side panel element 5 bridges the gap formed between the front panel element 3 and the rear panel element 4, the main planes of which extend essentially in parallel. The main plane of the side panel element(s) extend substantially perpendicular to the main planes of the front 3 and rear 4 panel elements. The front 3, rear 4, and side 5 panel element(s) together form a hollow shell. The space enclosed by the hollow shell is considered the interior of the housing structure and electronic device, while the space which is not enclosed by the hollow shell is considered the exterior.

The front panel element 3, the rear panel element 4, and the side panel element(s) 5 are preferably all made of glass. The glass may be single-layer or multi-layer, and it may be strengthened by means of a chemical strengthening process or reinforced by means of lamination. Furthermore, the thickness of the glass panel elements can be varied such that, e.g., the side panel elements are made of thicker, and more durable, glass.

A support frame 6, which supports the front panel element 3, rear panel element 4, and side 5 panel element(s) is arranged, at least partly, within this hollow shell. The support frame comprises a center frame member 7 which extends in between, and substantially in parallel with, the front panel element 3 and rear panel element 4. The center frame member 7 may be a solid plate, a recessed plate, one or several, solid or recessed, beams, or have any other suitable design which extends from one side of the electronic device to the other. Hence, the center frame member 7 has essentially the same width as the inner faces of the front panel element 3 and rear panel element 4.

The support frame 6 may be made of metal, plastic, or glass. The front panel element 3, the rear panel element 4, and the side 5 panel element(s) may be attached to the support frame 6 by means of adhesive, either permanently or removably. In one embodiment, the front panel element 3 and rear panel element 4 are removably attached to the support frame 6 by means of, e.g., reworkable glue, while the side panel element(s) 5 is/are permanently attached to the support frame 6 by means of, e.g., a permanent adhesive which provides additional strength to the side panel element(s). Any other configuration is of course also possible.

The support frame 6 may extend within the electronic device such that it is not in contact with any other components than the panel elements 3. The support frame 6 may also be in contact with, but not support, one or several electronic components arranged within the hollow shell formed by the surrounding panel elements such as the above-mentioned display, battery, circuit boards, etc. Additionally, the support frame 6 may function as a support for the above-mentioned one or several electronic components arranged within the hollow shell.

The edge 7a of the center frame member 7 is provided with an end frame member 8, to which the front panel element 3, rear panel element 4, and side 5 panel element(s) are attached. The support frame 6 may be provided with several end frame members 8, one or several per center frame member edge 7a. One end frame member 8 may be arranged at each opposing edge 7a, 7b of the center frame member 7, the center frame member 7 extending continuously between the two end frame members 8. The support frame 6 has at least the same width as the inner faces of the front 3 and rear 4 panel elements, and it may be wider as will be discussed farther below and as is shown in FIGS. 6 and 8.

In an embodiment, the end frame member 8 comprises a plate which extends perpendicular to the main plane 7c of the center frame member 7, i.e. perpendicular to the main planes of the front panel element 3 and rear panel element 4, such that the support frame 6 has an I-shaped cross-section. The front panel element 3 and rear panel element 4 panel are attached to the opposing edges of each end frame member 8, and the side panel element(s) 5 is/are attached to the outer face 8a of the end frame member 8, the outer face 8a extending between the opposing edges of the end frame member and facing towards the exterior.

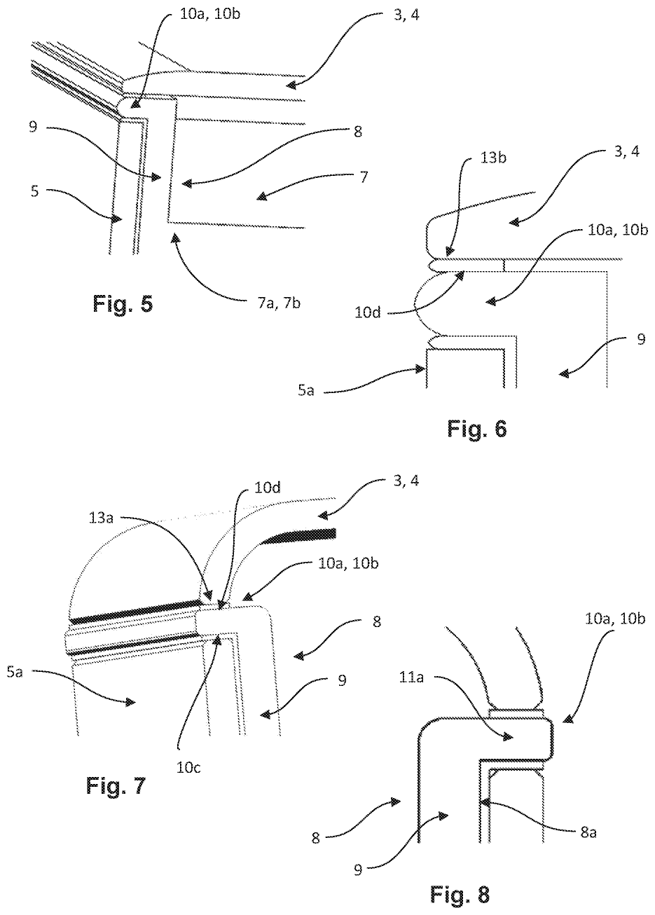

FIGS. 3 and 4 show further embodiments of the present disclosure, wherein the end frame member 8 comprises a web 9 and two flanges 10a, 10b (see also FIG. 5 to 7). The web 9 of the end frame member 8 extends perpendicular to the main plane 7c of the center frame member 7, and the flanges extend in parallel with the center frame member 7.

The edge 7a, 7b of the center frame member 7 is attached to the web 9 of the end frame member 8, preferably at the center of the web 9 such that the support frame 6 is symmetrical. The flanges 10a, 10b of the end frame member 8 comprise at least a plate-shaped section 11a which extends in parallel with the center frame member 7 and in a direction away from the center frame member 7, i.e. towards the exterior, such that the web 9 and flanges 10a, 10b together form a groove 12 having a U-shaped cross-section. The front panel element 3 is attached to the flange 10a of the end frame member 8, and the rear panel element 4 is attached to the opposing flange 10b of the same end frame member 8. One or several side panel elements 5 are attached to the web 9 of the end frame member 8, i.e. the side panel element(s) 5 is/are arranged within the groove 12 such that the side panel element(s) is/are surrounded at two sides by the flanges 10a, 10b.

The flanges 10a, 10b of the end frame member 8 may protrude past the outer face 5a of the side panel element 5, which is arranged in the groove 12, in a direction away from the center frame member 7, i.e. the flanges may protrude past the side panel element surface which is directed towards the exterior, such that the flanges 10a, 10b function as protective elements. This is shown more clearly in FIGS. 6 and 8. The flanges 10a, 10b can, e.g., absorb shock caused by dropping the electronic device 2 on the floor, hence reducing the risk that the panel elements are damaged.

The flanges 10a, 10b of the end frame member 8 have an inner face 10c and an outer face 10d, the inner face 10c being directed towards the opposite flange and the outer face 10d being directed towards the exterior. The front 3 and rear 4 panel elements are attached to the outer faces 10d of opposing flanges 10a, 10b of the end frame member 8.

As shown in FIGS. 3, 5, and 6, at least one of the front panel element 3 or the rear panel element 4 may be substantially plate-shaped, and the rear face 13b of the panel element 3, 4 is attached to the outer face 10d of the flange 10a, 10b of the end frame member 8.

As shown in FIGS. 4, 7, and 8, at least one of the front panel element 3 or the rear panel element 4 may have curved side sections 13, and the edge 13a of the curved side section 13 is attached to the outer face 10d of the flange 10a, 10b of the end frame member 8.

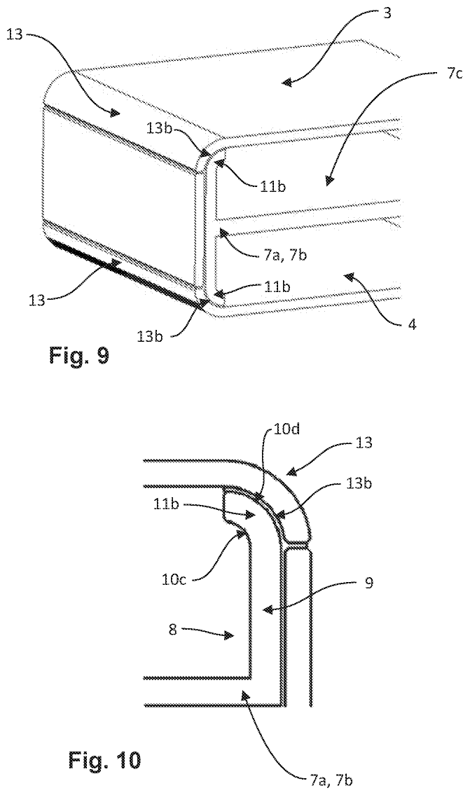

FIGS. 9 and 10 show a further embodiment of the present disclosure, wherein the flanges 10a, 10b of the end frame member 8 comprise at least a curved section 11b which is attached to the web 9 of the end frame member 8. The curved section 11b of the flanges 10a, 10b extends at least partially in a direction towards the center frame member 7, i.e. towards the interior of the housing structure/electronic device which is the opposite to the embodiments shown in FIGS. 3 to 8.

The front panel element 3 is attached to the flange 10a of the end frame member 8, and the rear panel element 4 is attached to the opposing flange 10b of the same end frame member 8. One or several side panel elements 5 are attached to the web 9 of the end frame member 8. The flange 10a, 10b of the end frame member 8 has an inner face 10c and an outer face 10d, and the front 3 and rear 4 panel elements are attached to the outer faces 10d of opposing flanges 10a, 10b of the end frame member 8. At least one of the front panel element 3 or the rear panel element 4 has curved side sections 13, and the rear face 13b of the curved side section 13 is attached to the outer face 10d of the flange 10a, 10b of the end frame member 8, more specifically to the outer face of the curved section 11b. The curved section 11b of the flanges 10a, 10b functions as an additional, inner support which strengthens the housing structure and reduces the risk of the panel elements being damaged if, e.g., dropping the electronic device 2 on the floor.

The various aspects and implementations has been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

The reference signs used in the claims shall not be construed as limiting the scope.

1-15. (canceled)

16. An electronic device comprising:
a front panel element and a rear panel element,
a side panel element bridging a gap formed between the front panel element and the rear panel element,
a support frame supporting the front panel element, rear panel element, and side panel element, comprising:
a center frame member extending in between the front panel element and rear panel element,
an end frame member arranged at an edge of the center frame member,
wherein the front panel element, rear panel element, and side panel element are attached to the end frame member;
wherein the front panel element, rear panel element, and side panel element are made of glass.

17. The electronic device according to claim 16, wherein the support frame comprises a plurality of end frame members, the end frame members being arranged at opposing edges of the center frame member, the center frame member extending continuously between the end frame members.

18. The electronic device according to claim 16, wherein the end frame member comprises a plate extending perpendicularly to a main plane of the center frame member, the front panel element and rear panel element being attached to opposing edges of the end frame member, the side panel element being attached to an outer face of the end frame member, the outer face extending between the opposing edges of the end frame member.

19. The electronic device according to claim 16, wherein the end frame member comprises a web and two opposing flanges, the web of the end frame member extending perpendicularly to a main plane of the center frame member and the edge of the center frame member being attached to the web of the end frame member,
the front panel element and rear panel element being attached to the flanges of the end frame member respectively, the side panel element being attached to the web of the end frame member.

20. The electronic device according to claim 19, wherein each of the flanges of the end frame member comprises at least a plate-shaped section which extends in parallel with the center frame member and in a direction away from the center frame member, the web and the flanges forming a groove, the side panel element being arranged in the groove surrounded at two sides by the flanges.

21. The electronic device according to claim 20, wherein the flanges of the end frame member protrude past an outer face of the side panel element, arranged in the groove, in a direction away from the center frame member.

22. The electronic device according to claim 19, wherein the flanges of the end frame member comprise at least a curved section attached to the web of the end frame member, the flanges of the end frame member extending in a direction towards the center frame member.

23. The electronic device according to any one of claim 19, wherein each of the flanges of the end frame member has an inner face and an outer face, the front panel element and the rear panel element being attached to the outer faces of opposing flanges of the end frame member.

24. The electronic device according to claim 23, wherein at least one of the front panel element or the rear panel element has a curved side section, and an edge of the curved side section is attached to the outer face of one of the flange of the end frame member.

25. The electronic device according to claim 23, wherein at least one of the front panel element or the rear panel element has a curved side section, and a rear face of the curved side section is attached to the outer face of one of the flange of the end frame member.

26. The electronic device according to claim 23, wherein at least one of the front panel element or the rear panel element is plate-shaped, and a rear face of the front panel element or the rear panel element is attached to the outer face of one of the flange of the end frame member.

27. The electronic device according to claim 16, wherein the support frame is made of metal.

28. The electronic device according claim 16, wherein the front panel element, the rear panel element, and the side panel element are attached to the support frame by means of adhesive.
